(19) United States
(12) Patent Application Publication
(10) Pub. No.: US 2024/0007910 A1
(43) Pub. Date: Jan. 4, 2024

(54) CANDIDATE CELL DETECTION FOR STANDALONE MODE

(71) Applicant: QUALCOMM INCORPORATED, San Diego, CA (US)

(72) Inventors: Xianwei Zhu, Beijing (CN); Jianqiang Zhang, Beijing (CN); Xuqiang Zhang, Beijing (CN); Xiaochen Chen, Beijing (CN); Xiaoning Lu, San Diego, CA (US); Yifan Du, Beijing (CN); Qiang Deng, Shenzhen (CN); Jinglei Tian, Shenzhen (CN); Jie Mao, Beijing (CN); Arvind Vardarajan Santhanam, San Diego, CA (US); Yong Hou, Beijing (CN); Shan Qing, San Diego, CA (US); Zhongyue Lou, Beijing (CN); Tom Chin, San Diego, CA (US); Wei-Jei Song, San Diego, CA (US); Mingchun Yang, San Diego, CA (US); Sathish Krishnamoorthy, Hyderabad (IN); Rajeev Pal, San Diego, CA (US)

(21) Appl. No.: 18/255,624

(22) PCT Filed: Jan. 22, 2021
(86) PCT No.: PCT/CN2021/073187

§ 371 Date: Jun. 2, 2023

(51) Int. Cl. H04W 36/00; H04W 36/32

(52) U.S. Cl. CPC H04W 36/0058; H04W 36/32

(57) ABSTRACT

Methods, systems, and devices for wireless communications are described. A user equipment (UE) may communicate with a base station according to a first radio access technology (RAT) in a first frequency range. The UE may perform measurements on a set of candidate cells of a second RAT or a second frequency range based on a determination for the UE to operate according to the second RAT or the second frequency range. The UE may perform a mobility procedure to establish a connection with a first cell of the set of candidate cells based on a determination that a first value of a first measurement parameter for the first cell satisfies a first threshold, and further based on a comparison of a different, second value of a second measurement parameter for the first cell to a second threshold.

### CROSS REFERENCE

The present Application is a 371 national stage filing of International PCT Application No. PCT/CN2021/073187 by Zhu et al. entitled “CANDIDATE CELL DETECTION FOR STANDALONE MODE,” filed Jan. 22, 2021, which is assigned to the assignee hereof, and which is expressly incorporated by reference in its entirety herein.

### FIELD OF TECHNOLOGY

The present disclosure relates to wireless communications, including candidate cell detection for standalone mode.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A UE may be configured to perform a mobility procedure from a first cell to a second cell. The UE may measure reference signals transmitted by a set of candidate cells and select, reselect, handover to, or other perform a mobility procedure towards, one of the candidate cells based on the measurements. Some existing techniques for mobility procedures may result in the UE selecting a cell with poor signal characteristics and can be improved.

### SUMMARY

The described techniques relate to improved methods, systems, devices, and apparatuses that support candidate cell detection for standalone mode. A user equipment (UE) may be configured to perform a mobility procedure, such as an inter-radio access technology (RAT) mobility procedure or an inter-frequency range mobility procedure. The UE may be configured to perform a network measurement-based mobility procedure or a network blind mobility procedure. For a network measurement-based mobility procedure, the UE may transmit a measurement report for candidate cells to a serving base station, and the serving base station may select one of the candidate cells. For a network blind mobility procedure, a serving base station may trigger the mobility procedure, and the UE may select a cell without additional network assistance from the serving base station.

Wireless communications systems described herein support techniques for enhanced mobility procedures. These enhanced techniques may be implemented for both network measurement-based mobility procedures and network blind mobility procedures. A UE may perform a mobility procedure based on a first measurement parameter and a internal measurement parameter. The first measurement parameter and the second measurement parameter may be different. For example, the first measurement parameter may be reference signal received power (RSRP), and the second measurement parameter may be reference signal received quality (RSRQ) or signal to interference plus noise ratio (SINR), or based on a combination of both RSRQ and SINR. In some cases, the first measurement parameter may be provided by the network, and the second measurement parameter may be determined by the UE or internal to the UE. For a network measurement-based mobility procedure, the UE may report a candidate cell which satisfies both the network-configured threshold and the internal threshold. For a network blind mobility procedure, the UE may similarly select a candidate cell which can satisfy both the network-configured and internal thresholds. For either mobility procedure, if none of the measured candidate cells can satisfy the internal threshold, the UE may report a candidate cell which can satisfy the network-configured measurement threshold and has a highest value for the second measurement parameter.

A method for wireless communications at a UE is described. The method may include communicating with a base station according to a first radio access technology in a first frequency range, performing measurements on a set of candidate cells of a second radio access technology or a second frequency range based on a determination for the UE to operate according to the second radio access technology or the second frequency range, and performing a mobility procedure to establish a connection with a first cell of the set of candidate cells based on a determination that a first value of a first measurement parameter for the first cell satisfies a first threshold, and further based on a comparison of a second value of a second measurement parameter for the first cell to a second threshold, the first measurement parameter being different from the second measurement parameter.

An apparatus for wireless communications at a UE is described. The apparatus may include a processor, memory in electronic communication with the processor, and instructions stored in the memory. The instructions may be executable by the processor to cause the apparatus to communicate with a base station according to a first radio access technology in a first frequency range, perform measurements on a set of candidate cells of a second radio access technology or a second frequency range based on a determination for the UE to operate according to the second radio access technology or the second frequency range, and perform a mobility procedure to establish a connection with a first cell of the set of candidate cells based on a determination that a first value of a first measurement parameter for the first cell satisfies a first threshold, and further based on a comparison of a second value of a second measurement parameter for the first cell to a second threshold, the first measurement parameter being different from the second measurement parameter.

Another apparatus for wireless communications at a UE is described. The apparatus may include means for communicating with a base station according to a first radio access technology in a first frequency range, means for performing measurements on a set of candidate cells of a second radio access technology or a second frequency range based on a determination for the UE to operate according to the second radio access technology or the second frequency range, and means for performing a mobility procedure to establish a connection with a first cell of the set of candidate cells based on a determination that a first value of a first measurement parameter for the first cell satisfies a first threshold, and further based on a comparison of a second value of a second measurement parameter for the first cell to a second threshold, the first measurement parameter being different from the second measurement parameter.

A non-transitory computer-readable medium storing code for wireless communications at a UE is described. The code may include instructions executable by a processor to communicate with a base station according to a first radio access technology in a first frequency range, perform measurements on a set of candidate cells of a second radio access technology or a second frequency range based on a determination for the UE to operate according to the second radio access technology or the second frequency range, and perform a mobility procedure to establish a connection with a first cell of the set of candidate cells based on a determination that a first value of a first measurement parameter for the first cell satisfies a first threshold, and further based on a comparison of a second value of a second measurement parameter for the first cell to a second threshold, the first measurement parameter being different from the second measurement parameter.

Some examples of the method, apparatuses, and non-transitory computer-readable medium described herein may further include operations, features, means, or instructions for receiving, from the base station, a configuration identifying resources for the UE to measure, where the configuration indicates the first measurement parameter and determining, by the UE, the second measurement parameter based on the first measurement parameter.

Some examples of the method, apparatuses, and non-transitory computer-readable medium described herein may further include operations, features, means, or instructions for receiving, from the base station, an indication for the UE to perform the mobility procedure and determining, by the UE, the first measurement parameter and the second measurement parameter.

Some examples of the method, apparatuses, and non-transitory computer-readable medium described herein may further include operations, features, means, or instructions for generating a database of measurements made by the UE of the second radio access technology or the second frequency range before the determination for the UE to operate according to the second radio access technology or the second frequency range, where the second threshold may be determined based on the database of measurements.

Some examples of the method, apparatuses, and non-transitory computer-readable medium described herein may further include operations, features, means, or instructions for receiving, from the base station, an indication of the first threshold and modifying the first threshold based on the database of measurements of the second radio access technology or the second frequency range.

In some examples of the method, apparatuses, and non-transitory computer-readable medium described herein, generating, in the database of measurements, a history of measurements for each idle neighboring cell or connected neighboring cell corresponding to the set of candidate cells made before the determination for the UE to operate according to the second radio access technology or the second frequency range.

Some examples of the method, apparatuses, and non-transitory computer-readable medium described herein may further include operations, features, means, or instructions for identifying the set of candidate cells based on the database of measurements.

In some examples of the method, apparatuses, and non-transitory computer-readable medium described herein, the first value of the first measurement parameter and the second value of the second measurement parameter may be obtained from the database of measurements.

In some examples of the method, apparatuses, and non-transitory computer-readable medium described herein, generating the database of measurements may include operations, features, means, or instructions for generating the database of measurements based on measurements made for the set of candidate cells according to the first measurement parameter and the second measurement parameter before the determination for the UE to operate according to the second radio access technology or the second frequency range.

Some examples of the method, apparatuses, and non-transitory computer-readable medium described herein may further include operations, features, means, or instructions for updating the database of measurements based on more recent measurements for the set of candidate cells.

Some examples of the method, apparatuses, and non-transitory computer-readable medium described herein may further include operations, features, means, or instructions for comparing a third value of the first measurement parameter for a second cell of the set of candidate cells to the first threshold, where the third value satisfies the first threshold, comparing a fourth value of the second measurement parameter for the second cell to the second threshold, where the fourth value fails to satisfy the second threshold, and initiating a monitoring window for measuring the set of candidate cells based on the fourth value failing to satisfy the second threshold.

Some examples of the method, apparatuses, and non-transitory computer-readable medium described herein may further include operations, features, means, or instructions for comparing a fifth value of the first measurement parameter for a third cell of the set of candidate cells to the first threshold, where the third value satisfies the first threshold, comparing a sixth value of the second measurement parameter for the third cell to the second threshold, where the sixth value fails to satisfy the second threshold, and storing an indicator for the third cell based on the sixth value of the second measurement parameter being higher than the fourth value.

Some examples of the method, apparatuses, and non-transitory computer-readable medium described herein may further include operations, features, means, or instructions for starting a measurement window timer after performing measurements on the second cell, and the third cell may be measured after an expiration of the measurement window timer.

Some examples of the method, apparatuses, and non-transitory computer-readable medium described herein may further include operations, features, means, or instructions for comparing the first value of the first measurement parameter for the first cell of the set of candidate cells to the first threshold, where the first value satisfies the first threshold and comparing the second value of the second measurement parameter for the first cell to the second threshold, where the second value satisfies the second threshold, and where the mobility procedure may be performed based on the second value of the second measurement parameter satisfying the second threshold.

In some examples of the method, apparatuses, and non-transitory computer-readable medium described herein, a duration for the monitoring window may be based on a mobility timeline requirement, a radio resource control connection status, a number of candidate cells of the set of candidate cells, or any combination thereof.

Some examples of the method, apparatuses, and non-transitory computer-readable medium described herein may further include operations, features, means, or instructions for comparing a third value of the first measurement parameter for a second cell of the set of candidate cells to the first threshold, where the third value fails to satisfy the first threshold and removing the second cell from the set of candidate cells.

Some examples of the method, apparatuses, and non-transitory computer-readable medium described herein may further include operations, features, means, or instructions for comparing the first value of the first measurement parameter for the first cell of the set of candidate cells to the first threshold, where the first value satisfies the first threshold and comparing the second value of the second measurement parameter for the first cell to the second threshold, where the second value satisfies the second threshold, and where the mobility procedure may be performed based on the second value of the second measurement parameter satisfying the second threshold.

Some examples of the method, apparatuses, and non-transitory computer-readable medium described herein may further include operations, features, means, or instructions for transmitting, to the base station, a measurement report indicating the first cell based on the second value of the second measurement parameter for the first cell.

Some examples of the method, apparatuses, and non-transitory computer-readable medium described herein may further include operations, features, means, or instructions for comparing the second value to a set of values generated for the second measurement parameter for at least a portion of the set of candidate cells, where the second value may be higher than each value of the set of values.

In some examples of the method, apparatuses, and non-transitory computer-readable medium described herein, the mobility procedure may be a cell reselection procedure, a cell redirection procedure, or a handover.

In some examples of the method, apparatuses, and non-transitory computer-readable medium described herein, the first measurement parameter may be RSRP, and the second measurement parameter may be RSRQ, or SINR, or a combination thereof.

In some examples of the method, apparatuses, and non-transitory computer-readable medium described herein, the first radio access technology and the second radio access technology may be a same radio access technology.

In some examples of the method, apparatuses, and non-transitory computer-readable medium described herein, the first radio access technology may be a different radio access technology from the second radio access technology.

In some examples of the method, apparatuses, and non-transitory computer-readable medium described herein, the first radio access technology may be New Radio and the second radio access technology may be Long Term Evolution.

In some examples of the method, apparatuses, and non-transitory computer-readable medium described herein, the first frequency range and the second frequency range may be a same frequency range.

In some examples of the method, apparatuses, and non-transitory computer-readable medium described herein, the first frequency range may be a different frequency range from the second frequency range.

In some examples of the method, apparatuses, and non-transitory computer-readable medium described herein, the first frequency range may be Frequency Range 2 and the second frequency range may be Frequency Range 1 or Frequency Range.

### BRIEF DESCRIPTION OF THE DRAWINGS

FIG. 1 illustrates an example of a wireless communications system that supports candidate cell detection for standalone mode in accordance with aspects of the present disclosure.

FIG. 2 illustrates an example of a wireless communications system that supports candidate cell detection for standalone mode in accordance with aspects of the present disclosure.

FIG. 3 illustrates an example of a network measurement-based mobility procedure flow that supports candidate cell detection for standalone mode in accordance with aspects of the present disclosure.

FIG. 4 illustrates an example of a network blind mobility procedure flow that supports candidate cell detection for standalone mode in accordance with aspects of the present disclosure.

FIGS. 5 and 6 show block diagrams of devices that support candidate cell detection for standalone mode in accordance with aspects of the present disclosure.

FIG. 7 shows a block diagram of a communications manager that supports candidate cell detection for standalone mode in accordance with aspects of the present disclosure.

FIG. 8 shows a diagram of a system including a device that supports candidate cell detection for standalone mode in accordance with aspects of the present disclosure.

FIGS. 9 through 11 show flowcharts illustrating methods that support candidate cell detection for standalone mode in accordance with aspects of the present disclosure.

### DETAILED DESCRIPTION

A user equipment (UE) may support communication according to one or more radio access technologies (RATs). For example, the UE may support Long Term Evolution (LTE) communications, New Radio (NR) communications. The UE may communicate with a base station on one or more radio frequency spectrum bands within a frequency range (FR), such as FR1 and FR2. In some cases, the UE may be configured to perform a mobility procedure, such as an inter-RAT mobility procedure or an inter-FR mobility procedure. The UE may be configured to perform a network measurement-based mobility procedure or a network blind mobility procedure. For a network measurement-based mobility procedure, the UE may transmit a measurement report for candidate cells to a serving base station, and the serving base station may select one of the candidate cells. For a network blind mobility procedure, a serving base station may trigger the mobility procedure, and the UE may select a cell without additional network assistance from the serving base station regarding the selection of the candidate cell (e.g., without sending a measurement report to the serving base station).

In some wireless communications systems, a UE may select cells for a mobility procedure based on one measurement parameter, such as reference signal received power (RSRP). The UE may measure reference signals transmitted by candidate cells to perform the measurements. In these systems, the UE may select the first candidate cell with an RSRP measurement that satisfies a network-configured threshold. However, performing a mobility procedure based just on one measurement parameter may be inadequate for some scenarios. For example, a cell with high RSRP may still have poor quality or experience interference and noise. If the UE switches to a cell with poor quality or excessive interference and noise, the UE may still disconnect from the cell, which may lead to outcomes that cannot be recovered by performing another mobility procedure.

Wireless communications systems described herein support techniques for enhanced mobility procedures. These enhanced techniques may be implemented for both network measurement-based mobility procedures and network blind mobility procedures. A UE may perform a mobility procedure based on a first measurement parameter and a second measurement parameter. The first measurement parameter and the second measurement parameter may be different. For example, the first measurement parameter may be RSRP, and the second measurement parameter may be reference signal received quality (RSRQ) or signal to interference plus noise ratio (SINR) or based on a combination thereof. In some cases, the first measurement parameter may be provided by the network, and the second measurement parameter may be determined at the UE or be internal to the UE. In other examples, other measurements parameters may be used for the first measurement parameter, the second measurement parameter, or both. For example, other measurement parameters for signal strength, signal quality, or a combination of these, may be used. For a network measurement-based mobility procedure, the UE may report a candidate cell which satisfies both the first threshold and the second threshold. For a network blind mobility procedure, the UE may similarly select a candidate cell which can satisfy both the first and second thresholds. For either mobility procedure, if none of the measured candidate cells can satisfy the second threshold, the UE may report a candidate cell which can satisfy the first measurement threshold and has a highest value for the second measurement parameter. These techniques may reduce an interaction failure rate between RATs of an inter-RAT mobility procedure and generally save power at the UE due to efficient cell acquisition and re-establishment.

Aspects of the disclosure are initially described in the context of wireless communications systems. Aspects of the disclosure are further illustrated by and described with reference to apparatus diagrams, system diagrams, and flowcharts that relate to candidate cell detection for standalone mode.

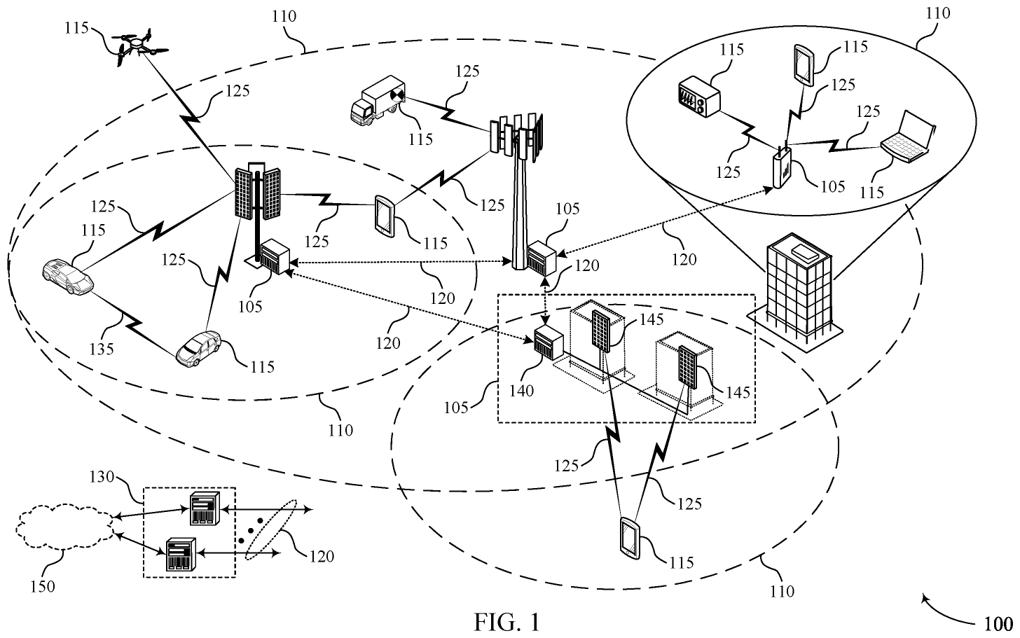

FIG. 1 illustrates an example of a wireless communications system 100 that supports candidate cell detection for standalone mode in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, or low-latency, or both functions. Ultra-reliable communications may include private communication or group communication and may be supported by one or more services such as push-to-talk (PTT), video, or data. Support for ultra-reliable, low-latency, or both functions may include prioritization of services, which may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may be configured to perform a mobility procedure, such as an inter-RAT mobility procedure or an inter-FR mobility procedure. The UE 115 may be configured to perform a network measurement-based mobility procedure or a network blind mobility procedure. For a network measurement-based mobility procedure, the UE 115 may transmit a measurement report for candidate cells to a serving base station 105, and the serving base station 105 may select one of the candidate cells. For a network blind mobility procedure, a serving base station 105 may trigger the mobility procedure, and the UE 115 may select a cell without additional network assistance from the serving base station.

Wireless communications systems described herein, such as the wireless communications system 100, support techniques for enhanced mobility procedures. These enhanced techniques may be implemented for both network measurement-based mobility procedures and network blind mobility procedures. A UE 115 may perform a mobility procedure based on a first, network measurement parameter and a second measurement parameter. The first network measurement parameter and the second measurement parameter may be different. For example, the first network measurement parameter may be RSRP, and the second measurement parameter may be RSRQ or SINR, or based on a combination of both RSRQ and SINR. In some cases, the first measurement parameter may be provided by the network, and the second measurement parameter may be determined by the UE or internal to the UE. In other examples, other measurements parameters may be used for the first measurement parameter, the second measurement parameter, or both. For example, other measurements of signal strength, signal quality, or a combination of these, may be used. For a network measurement-based mobility procedure, the UE 115 may report a candidate cell which satisfies both the first threshold and the second threshold. For a network blind mobility procedure, the UE 115 may similarly select a candidate cell which can satisfy both the first and second thresholds. For either mobility procedure, if none of the measured candidate cells can satisfy the second threshold, the UE 115 may report a candidate cell which can satisfy the first measurement threshold and has a highest value for the second measurement parameter.

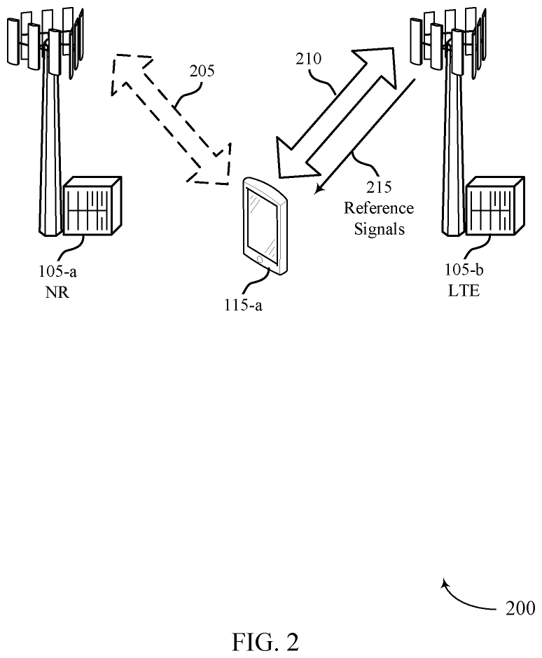

FIG. 2 illustrates an example of a wireless communications system 200 that supports candidate cell detection for standalone mode in accordance with aspects of the present disclosure. The wireless communications system 200 may include UE 115-a, base station 105-a, and base station 105-b. UE 115-a may be an example of a UE 115 as described with reference to FIG. 1, and base station 105-a and base station 105-b may each be an example of a base station 105 as described with reference to FIG. 1.

UE 115-a may support communication with a base station 105 according to one or more RATs. For example, UE 115-a may communicate according to LTE, NR, or both, among other types of RATs. UE 115-a may communicate with a base station 105 on one or more radio frequency spectrum bands within a frequency range. For example, FR1 may span from about 410 MHz to 7125 MHz, FR2 may span from about 24250 MHz to 52600 MHz, FR3 may be between FR1 and FR2, from about 7125 MHz to 24250 MHZ, and FR4 and FR5 may be at higher frequencies (e.g., higher than FR2). The different FRs may provide different data rates. For example, FRs with higher frequencies may provide higher data rates, but the higher frequencies may also have a shorter communication range.

In an example, UE 115-a may be connected to base station 105-a to communicate according to a first RAT in a first FR. For example, UE 115-a may be connected to base station 105-a via a first connection 205 for NR communication services in FR2. UE 115-a may operate in a standalone mode, where base station 105-a conveys both user plane information and control plane information to UE 115-a from an NR entity.

In some cases, UE 115-a may be configured to perform an inter-RAT mobility procedure. For example, UE 115-a may be configured to perform an inter-RAT cell reselection, an inter-RAT cell redirection, or an inter-RAT packet switched handover (PSHO). For an inter-RAT mobility procedure, UE 115-a may release an RRC connection with the connected cell (e.g., releasing the NR connection with base station 105-a) to connect or select a different cell of a different RAT. The inter-RAT cell reselection procedure may configure UE 115-a to select a different cell of the different RAT to camp on while in an idle mode. The inter-RAT cell redirection may configure UE 115-a to release an active RRC connection, redirecting UE 115-a to a different frequency to establish an RRC connection on a cell of the different RAT. The inter-RAT PSHO may configure UE 115-a to perform a handover between a cell for a first RAT to a cell for a second RAT. While these examples are given in the context of an inter-RAT mobility procedure (e.g., selection, reselection, handover), similar techniques may be implemented for switching between FRs. For example, UE 115-a may be configured for an inter-FR mobility procedure within a same RAT or across different RATs. In some examples, these techniques may also be in the context inter-RAT mobility procedure where the FR remains the same. In some examples, the FR may remain the same, but different frequencies or sets of frequencies may be used for communications (e.g., different channels, different component carriers, different subcarriers).

UE 115-a may be configured to perform a network measurement-based mobility procedure or a network blind mobility procedure. For a network measurement-based mobility procedure, UE 115-a may transmit a measurement report for candidate cells, and base station 105-a select one of the candidate cells. UE 115-a may receive an RRC message to initiate the mobility procedure to the selected cell. For a network blind mobility procedure, base station 105-a may trigger the mobility procedure, and UE 115-a may select the cell without additional network assistance from base station 105-a regarding the selection of the cell (e.g., autonomously performing the mobility procedure).

For example, base station 105-a may transmit an RRC message configuring UE 115-a to perform an inter-RAT mobility procedure, or inter-FR mobility procedure, or both, and UE 115-a may search for a different cell of a different RAT. In some cases, UE 115-a may attach to base station 105-b after performing the mobility procedure, either by camping on base station 105-b or establishing a second connection 210 for services, such as NR services, with base station 105-b. UE 115-a may release the first connection 205 with base station 105-a. Base station 105-b may provide communication services according to a second RAT, such as LTE, or communications services in a second FR, or both.

In some wireless communications systems, a UE 115 may select cells for a mobility procedure based on one measurement parameter, such as RSRP. The UE 115 may measure reference signals transmitted by candidate cells to perform the measurements. For a network measurement-based mobility procedure, the UE 115 may report the first candidate cell with an RSRP measurement that satisfies a network-configured threshold. For a network blind mobility procedure, the UE 115 may perform the mobility procedure to switch to the first cell with an RSRP measurement that satisfies the network-configured threshold. However, performing a mobility procedure based just on RSRP may be inadequate for some scenarios, as a cell with high RSRP (e.g., relative to an RSRP threshold, or compared to other candidate cells) may still have poor quality (e.g., low RSRQ or low SINR compared to an RSRQ threshold or SINR threshold, respectively, or low compared to the RSRQ or SINR, respectively, of other candidate cells). If the UE 115 switches to a cell with poor quality or SINR, the UE 115 may still disconnect from the cell, which may lead to outcomes that cannot be recovered (or easily recovered, e.g., within a time to avoid a lost connection) by performing another mobility procedure, such as a dropped call.

Wireless communications systems described herein, such as the wireless communications system 200, provide techniques for enhanced mobility procedures. These enhanced techniques may be implemented for both network measurement-based mobility procedures and network blind mobility procedures. UE 115-a may perform a mobility procedure based on a first measurement parameter, such as RSRP, and a second measurement parameter, such as RSRQ, SINR, or a combination thereof. The second measurement parameter may be internal to UE 115-a. For example, the second measurement parameter and a second threshold for the second measurement parameter may be determined by UE 115-a. In some cases, a third party may provide a process or algorithm for UE 115-a to determine the second measurement parameter or second threshold, or both. For example, a UE manufacturer, a chipset manufacturer, or a network operator may provide the process or algorithm for UE 115-a to determine the second measurement parameter or second threshold.

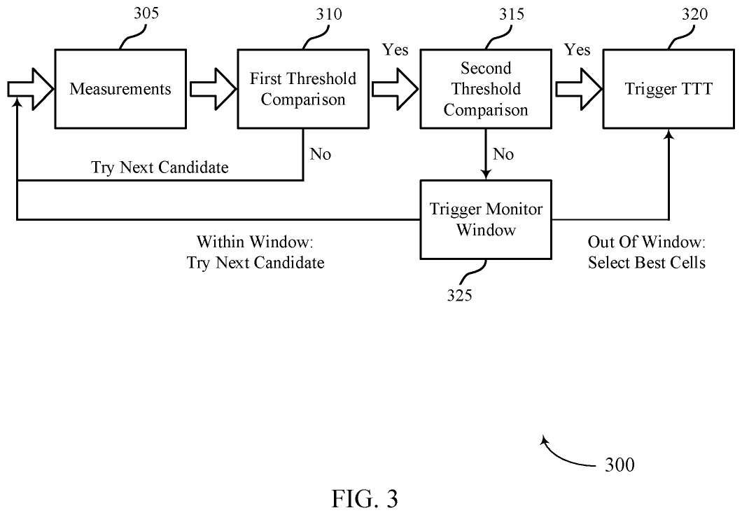

For a network measurement-based mobility procedure, UE 115-a may measure reference signals, such as CSI-RS, transmitted by candidate cells. For example, base station 105-a may send a configuration to UE 115-a indicating measurement resources for a set of candidate cells, and UE 115-a may measure reference signals 215 from a first candidate cell provided by base station 105-b. UE 115-a determine whether measurements on the reference signals 215 exceed a first threshold for a first measurement parameter, such as RSRP. If the first threshold is not satisfied, UE 115-a may check the next candidate cell. If the first threshold is satisfied, UE 115-a may determine whether the measurements for the reference signals 215 exceed a second threshold for a second measurement parameter, such as RSRQ or SINR. If the second threshold is satisfied, UE 115-a may transmit a measurement report indicating base station 105-b to base station 105-a, and base station 105-a may send another RRC message to initiate the mobility procedure. If the second threshold is not satisfied, UE 115-a may check other candidate cells. In some cases, UE 115-a may check other candidate cells for a certain duration of time. If none of the candidate cells satisfy the second threshold within the duration of time, UE 115-a may report a candidate cell which satisfies the first threshold and has a highest measurement for the second measurement parameter. Techniques for network measurement-based mobility procedures are described in more detail with reference to FIG. 3.

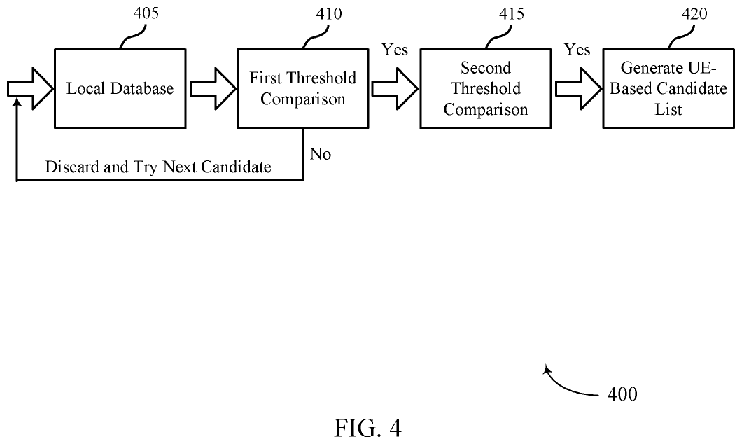

For a network blind mobility procedure, UE 115-a may populate a database of candidate cells based on UE local history information. In some cases, the database may include reference signal measurements for the candidate cells, which may have been made prior to the network blind mobility procedure being triggered. Additionally, or alternatively, UE 115-a may measure reference signals from the candidate cells (e.g., after the network blind mobility procedure is triggered). UE 115-a may determine whether measurements for a candidate cell exceed a first threshold for a first measurement parameter, such as RSRP. If the first threshold is not satisfied, UE 115-a may discard the candidate cell from consideration and check a next candidate cell. If the first threshold is satisfied, UE 115-a may determine whether the measurements for the candidate cell exceed a second threshold for a second measurement parameter, such as RSRQ or SINR. If the second threshold is satisfied, UE 115-a may perform the mobility procedure to the candidate cell. Otherwise, UE 115-a may check the next candidate cell. If none of the candidate cells satisfy the second threshold, UE 115-a may switch to a candidate cell which satisfies the first measurement threshold and has a highest value for the second measurement parameter. Techniques for network blind mobility procedures are described in more detail with reference to FIG. 4.

These techniques may reduce an interaction failure rate between RATs of an inter-RAT mobility procedure. Additionally, UE 115-a may save power due to efficient cell acquisition and re-establishment. These techniques may enable UE 115-a to camp on a cell with higher quality and signal strength to improve voice communications and throughput performance. Additionally, UE 115-a may avoid frequent mobility procedures, which may be caused by selecting cells with low signal quality, ensuring robust voice communications setup and network maintenance.

In some example described herein, separate base stations 105 may provide the RATs or FRs for the described mobility procedures. However, in some cases, one base station 105 may provide both RATs for an inter-RAT mobility procedure or both FRs for an inter-FR mobility procedure. For example, base station 105-b may provide both an LTE connection and an FR connection, and UE 115-a may perform an inter-RAT mobility procedure using the techniques described herein to connect to an LTE cell provided by base station 105-b from an NR cell provided by base station 105-b. Similarly, base station 105-b may provide radio frequency spectrum bands in FR1 and FR2, and UE 115-a may perform an inter-FR mobility procedure using the techniques described herein to connect to an FR1 cell provided by base station 105-b from an FR2 cell provided by base station 105-b.

FIG. 3 illustrates an example of a network measurement-based mobility procedure flow 300 that supports candidate cell detection for standalone mode in accordance with aspects of the present disclosure.

A UE 115 may be configured to perform a network measurement-based mobility procedure. For example, a first base station 105 may transmit an RRC message configuring the UE 115 to perform the network measurement-based mobility procedure to a cell of a different RAT (in a same or different FR), or a cell operating in a different FR (in a same or different RAT), or a cell operating according to a different RAT in a different FR. In some cases, the RRC message may indicate one or more candidate cells or measurement resources for the candidate cells. The UE 115 may measure reference signals, such as CSI-RS, transmitted by the candidate cells for the mobility procedure. In some cases, the RRC message may indicate a network-configured measurement parameter, which the UE 115 may use to determine whether a candidate cell should be selected for the mobility procedure. UEs 115 described herein may use the network-indicated measurement parameter and one or more UE-determined, or internal, measurement parameters for mobility procedures.

For a network measurement-based mobility procedure, the UE 115 may measure a set of candidate cells of a second RAT or a second FR based on a determination for the UE 115 to operate according to the second RAT or the second FR. The UE 115 may compare measurements for the set of candidate cells to a set of thresholds and report a cell with measurements that satisfy the set of thresholds to the first base station 105. The first base station 105 may then configure the UE 115 to perform the mobility procedure to the indicated cell. In some cases, the UE 115 may receive a configuration from the base station 105, the configuration indicating resources for the UE 115 to measure.

For example, the UE 115 may be configured to perform the network measurement-based mobility procedure and perform measurement on reference signals for the mobility procedure at 305. The UE 115 may measure reference signals from a first candidate cell and determine a first value for a first measurement parameter. In some cases, the first measurement parameter may be RSRP, RSRQ, or SINR, or any combination thereof. The UE 115 may compare the first value to a first threshold for the first measurement parameter at 310. If the first value does not exceed the first threshold, the UE 115 may check a second candidate cell and take measurements of reference signals transmitted by the second candidate cell.

If the first value exceeds the first threshold, the UE 115 may compare a second value for a second measurement parameter to a second threshold at 315. The second measurement parameter may be, for example, RSRP, RSRQ, or SINR, or any combination thereof. In some cases, the second measurement parameter may be different than the first measurement parameter. For example, the UE 115 may check RSRP at 310 then RSRQ at 315. In some examples, the second measurement parameter may be determined based on the first measurement parameter. For example, the UE 115 may receive the configuration via an RRC message to measure RSRP for the mobility procedure, and the UE 115 may determine to measure RSRQ, SINR, or another measurement parameter different from RSRP, at 315, based on the indication to measure the RSRP.

The second measurement parameter or the second threshold may be based on a UE history or a database of measurements. In some cases, the second threshold may be determined on a per-candidate cell basis. For example, the UE 115 may determine that the UE 115 failed to decode a signal such as a physical broadcast channel (PBCH) from one of the candidate cells due to poor RSRQ, or the UE 115 may determine that the UE 115 experienced radio link failure with the candidate cell within a short amount of time due to worse quality resulting in CRC errors. The UE 115 may manage or store a database of connection logs, measurements, RRC events, or any combination thereof, which may be used to determine the second threshold or second threshold metric. In some cases, the database may be generated based on information from multiple UEs 115, and the database information may be broadcast to UEs 115.

If the second value for the second measurement parameter of the first candidate cell satisfies the second threshold, the UE 115 may detect a time-to-trigger (TTT) at 320. The UE 115 may send a report to the base station 105 indicating the first candidate cell after the TTT. In some cases, the UE 115 may indicate that the candidate cell satisfies the mobility procedure criteria. For example, the UE 115 may transmit a measurement report including the first value for the first measurement parameter or the second value for the second measurement parameter, or both.

If the second value for the second measurement parameter does not satisfy the second threshold, the UE 115 may trigger a monitor window at 325. The UE 115 may monitor reference signals from the other candidate cells during the window to find a candidate cell which satisfies both the first measurement parameter and the second measurement parameter. In some cases, the duration of the monitoring window may be dynamically changed. For example, the duration of the monitoring window may be determined per-scenario or based on a timeline requirement. The UE 115 may perform a best effort detection for a high quality cell within the monitoring window. In some cases, the UE 115 may wait for a cool-down duration between measuring a first candidate cell and a second candidate cell, which may provide time for borderline cells to recover the SINR or RSRQ.

While the monitoring window is active, the UE 115 may measure reference signals from other candidate cells of the set of candidate cells. For example, the UE 115 may take measurements on reference signals transmitted by a second candidate cell at 305. For the second candidate cell, the UE 115 may determine a third value for the first measurement parameter and compare the third value to the first threshold at 310. If the third value does not satisfy the first measurement threshold, the UE 115 may perform measurements for the next (e.g., a third) candidate cell. If the third value exceeds the first threshold, the UE 115 may determine a fourth value for the second measurement parameter and compare the fourth value to the second threshold at 315. If the fourth value does not exceed the second threshold, the UE 115 may perform measurements for the next candidate cell if the monitor window timer is still active. If the fourth value exceeds the second threshold, the UE 115 may report the second candidate cell to the base station 105.

In some cases, the UE 115 may retain cell identifiers for candidate cells which satisfy the first measurement threshold for the first measurement parameter but not the second measurement threshold for the second measurement parameter. For example, a candidate cell may have high enough RSRP to exceed the first threshold but not high enough RSRQ to satisfy the second threshold. While the network may support a mobility procedure to any candidate cell which satisfies the first threshold for the first measurement parameter, the UE 115 may support techniques to further select a higher quality cell from candidate cells which satisfy the first measurement parameter.

For example, after the monitor window expire, the UE 115 may not have identified a candidate cell which satisfies the second threshold for the second measurement parameter. However, multiple cells may have satisfied the first threshold for the first measurement parameter. The UE 115 may report a candidate cell which satisfied the first threshold and has the highest value for the second measurement parameter of the measured candidate cells. For example, instead of reporting the first candidate cell which satisfied the first measurement threshold for the first measurement parameter, the UE 115 may report the highest quality cells (e.g., highest value for the second measurement parameter) of those which satisfy the first measurement threshold, even if none of the measured cells satisfy the second threshold.

By implementing these techniques, the UE 115 may perform the mobility procedure to establish a connection with a cell of the set of candidate cells based on a determination that a first value of the first measurement parameter for the cell satisfies a threshold, and further based on a comparison of a second value of the second measurement parameter for the cell to the second threshold. The UE 115 may be redirected or handed over to the cell, or the UE 115 may reselect to the cell, performing the mobility procedure.

FIG. 4 illustrates an example of a network blind mobility procedure flow 400 that supports candidate cell detection for standalone mode in accordance with aspects of the present disclosure.

A UE 115 may be configured to perform a network blind mobility procedure. For example, a first base station 105 may transmit an RRC message configuring the UE 115 to perform the network blind mobility procedure to a cell of a different RAT, or a cell operating in a different FR, or a cell operating according to a different RAT in a different FR.

When the network triggers the network blind mobility procedure, the UE 115 may populate a database of UE history information to assist or reduce a time of the mobility procedure. In some cases, the database may indicate a list or an ordering of a set of candidate cells the UE 115 is to measure. For example, there may be a set of five candidate cells in the database (e.g., f1 through f5), and the database may indicate an order to check the candidate cells (e.g., f4 first, then f1, etc.). In some cases, there may be different rankings for different network event metrics, such as different rankings for measuring RSRP, RSRQ, and SINR. In some cases, the database may include a history of measurements made for the candidate cells by UEs 115 operating in an idle mode or connected mode. In some cases, database may include connection logs, measurements, RRC events, or any combination thereof, which may be used to determine the second threshold or second measurement parameter. In some cases, the database may be generated based on information from multiple UEs 115, and the database information may be broadcast to UEs 115. Some aspects of this database may similarly be used for network measurement-based mobility procedures.

The database may be updated periodically. For example, as the UE 115 takes measurements of the candidate cells, the UE 115 may update the database. Similarly, other UEs 115 may perform measurements, and then provide such measures so that the database may be updated at the network. The updates may be indicated to the UEs 115 for up-to-date measurement information.

The UE 115 may use the measurement information in the database for the network blind mobility procedure. In some cases, the RRC message may indicate a network-configured measurement parameter, which the UE 115 may use as a first measurement parameter to determine whether a candidate cell should be selected for the mobility procedure. Additionally, or alternatively, the first measurement parameter may be determined at the UE 115. For example, the UE 115 may determine the first measurement parameter based on the database. In some cases, the RRC message may indicate the network-configured measurement parameter, and the UE 115 may update the network-configured measurement parameter based on information in the database.

For example, the UE 115 may be configured to perform the network blind mobility procedure, and the UE 115 may obtain measurement information for a first candidate cell at 405. The first candidate cell may be determined based on the ranking indicated by the database. In some cases, the first measurement parameter may be RSRP, RSRQ, or SINR. The UE 115 may compare a first value for the first measurement parameter of a first candidate cell to a first threshold at 410. If the first value does not exceed the first threshold, the UE 115 may discard or exclude the first candidate cell from consideration check the measurement information for a second candidate cell.

If the first value exceeds the first threshold, the UE 115 may compare a second value for a second measurement parameter to a second threshold at 415. The second measurement parameter may be, for example, RSRP, RSRQ, or SINR, or any combination thereof. In some cases, the second measurement parameter may be different than the first measurement parameter. For example, the UE 115 may check RSRP at 410 then RSRQ at 415. In some examples, the second measurement parameter may be determined based on the first measurement parameter. For example, the UE 115 may receive the configuration via an RRC message to measure RSRP for the mobility procedure, and the UE 115 may determine to measure RSRQ, SINR, or a measurement parameter other than RSRP, at 415, based on the indication to measure the RSRP. Additionally, or alternatively, the second measurement parameter may be determined based on information in the database.

If the second value for the second measurement parameter of the first candidate cell satisfies the second threshold, the UE 115 may include the first candidate cell in a UE-based candidate list at 420. In some cases, the UE 115 may perform the mobility procedure based on detecting a candidate cell which satisfies both the first threshold and the second threshold. In some examples, the UE 115 may continue to perform measurements on other candidate cells to identify another candidate cell which may have a higher value for the second measurement parameter.

If the second value for the second measurement parameter does not satisfy the second threshold, the UE 115 may check a second candidate cell. In some cases, the second candidate cell may be a next-ranked candidate cell according to the database. The UE 115 may continue to perform comparisons for the set of candidate cells to find a candidate cell which satisfies both the first measurement parameter and the second measurement parameter.

In some cases, the UE 115 may retain cell identifiers for candidate cells which satisfy the first measurement threshold for the first measurement parameter but not the second measurement threshold for the second measurement parameter. For example, a candidate cell may have high enough RSRP to exceed the first threshold but not high enough RSRQ to satisfy the second threshold. While the network may support a mobility procedure to any candidate cell which satisfies the first threshold for the first measurement parameter, the UE 115 may support techniques to further select a higher quality cell from candidate cells which satisfy the first measurement parameter.

For example, after checking each candidate cell in the set of candidate cells, the UE 115 may not have identified a candidate cell which satisfies the second threshold for the second measurement parameter. However, multiple cells may have satisfied the first threshold for the first measurement parameter. The UE 115 may perform the mobility procedures to a candidate cell which satisfied the first threshold and has the highest value for the second measurement parameter of the candidate cells.

By implementing these techniques, the UE 115 may perform the mobility procedure to establish a connection with a cell of the set of candidate cells based on a determination that a first value of the first measurement parameter for the cell satisfies a threshold, and further based on a comparison of a second value of the second measurement parameter for the cell to the second threshold. The UE 115 may be redirected or handed over to the cell, or the UE 115 may reselect to the cell, performing the mobility procedure.

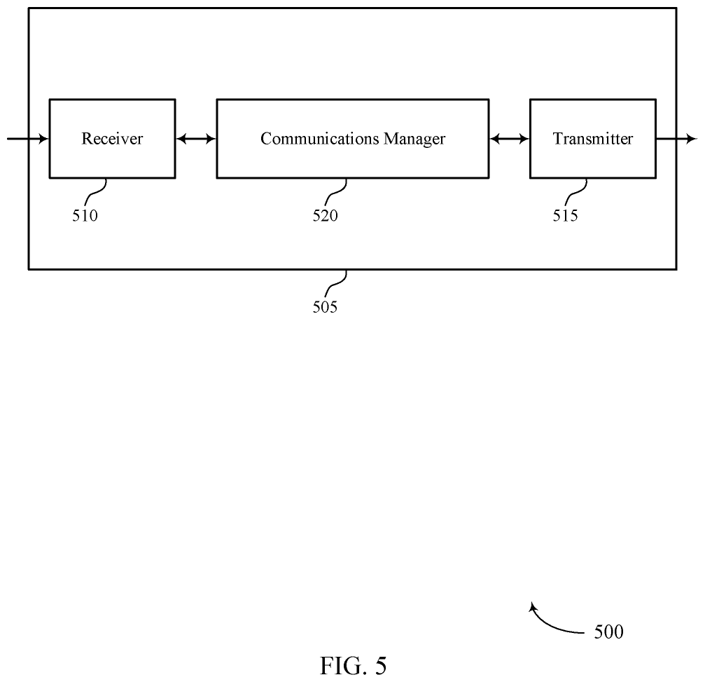

FIG. 5 shows a block diagram 500 of a device 505 that supports candidate cell detection for standalone mode in accordance with aspects of the present disclosure. The device 505 may be an example of aspects of a UE 115 as described herein. The device 505 may include a receiver 510, a transmitter 515, and a communications manager 520. The device 505 may also include one or more processors, memory coupled with the one or more processors, and instructions stored in the memory that are executable by the one or more processors to enable the one or more processors to perform the mobility procedure features discussed herein. Each of these components may be in communication with one another (e.g., via one or more buses).

The receiver 510 may provide a means for receiving information such as packets, user data, control information, or any combination thereof associated with various information channels (e.g., control channels, data channels, information channels related to candidate cell detection for standalone mode). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to candidate cell detection for standalone mode). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of candidate cell detection for standalone mode as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for communicating with a base station according to a first radio access technology in a first frequency range. The communications manager 520 may be configured as or otherwise support a means for performing measurements on a set of candidate cells of a second radio access technology or a second frequency range based on a determination for the UE to operate according to the second radio access technology or the second frequency range. The communications manager 520 may be configured as or otherwise support a means for performing a mobility procedure to establish a connection with a first cell of the set of candidate cells based on a determination that a first value of a first measurement parameter for the first cell satisfies a first threshold, and further based on a comparison of a second value of a second measurement parameter for the first cell to a second threshold, the first measurement parameter being different from the second measurement parameter.

By including or configuring the communications manager 520 in accordance with examples as described herein, the device 505 (e.g., a processor controlling or otherwise coupled to the receiver 510, the transmitter 515, the communications manager 520, or a combination thereof) may support techniques to save power at a UE 115 due to efficient cell acquisition and re-establishment. These techniques may enable the UE 115 to camp on a cell with higher quality and signal strength to improve voice communications and throughput performance. Additionally, the UE 115 may avoid frequent mobility procedures, which may be caused by selecting cells with low signal quality, ensuring robust voice communications setup and network maintenance.

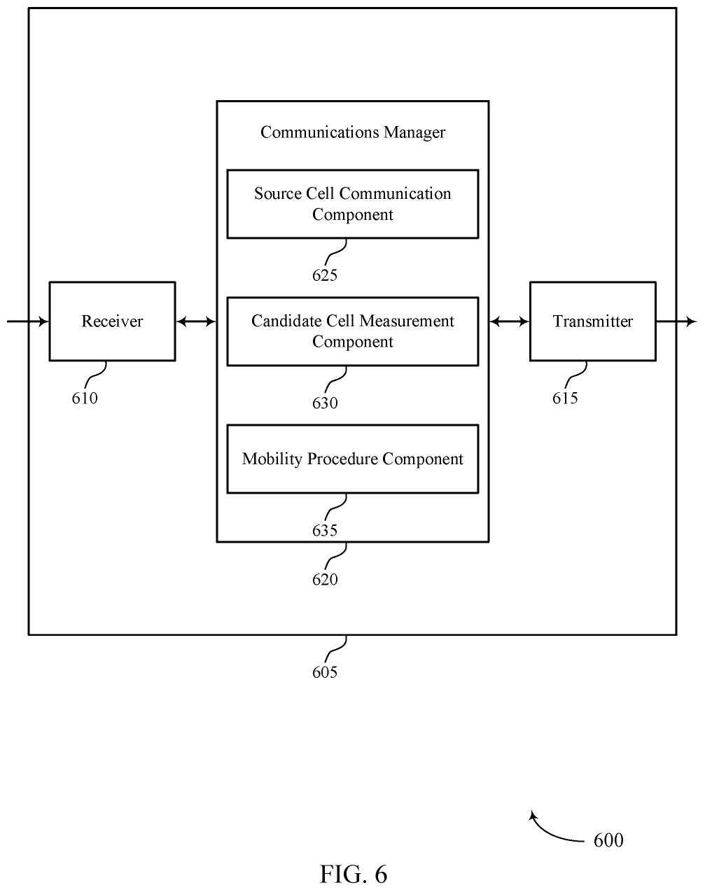

FIG. 6 shows a block diagram 600 of a device 605 that supports candidate cell detection for standalone mode in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to candidate cell detection for standalone mode). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to candidate cell detection for standalone mode). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of candidate cell detection for standalone mode as described herein. For example, the communications manager 620 may include a source cell communication component 625, a candidate cell measurement component 630, a mobility procedure component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The source cell communication component 625 may be configured as or otherwise support a means for communicating with a base station according to a first radio access technology in a first frequency range. The candidate cell measurement component 630 may be configured as or otherwise support a means for performing measurements on a set of candidate cells of a second radio access technology or a second frequency range based on a determination for the UE to operate according to the second radio access technology or the second frequency range. The mobility procedure component 635 may be configured as or otherwise support a means for performing a mobility procedure to establish a connection with a first cell of the set of candidate cells based on a determination that a first value of a first measurement parameter for the first cell satisfies a first threshold, and further based on a comparison of a second value of a second measurement parameter for the first cell to a second threshold, the first measurement parameter being different from the second measurement parameter.

In some cases, the source cell communication component 625, the candidate cell measurement component 630, and the mobility procedure component 635 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the source cell communication component 625, the candidate cell measurement component 630, and the mobility procedure component 635 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

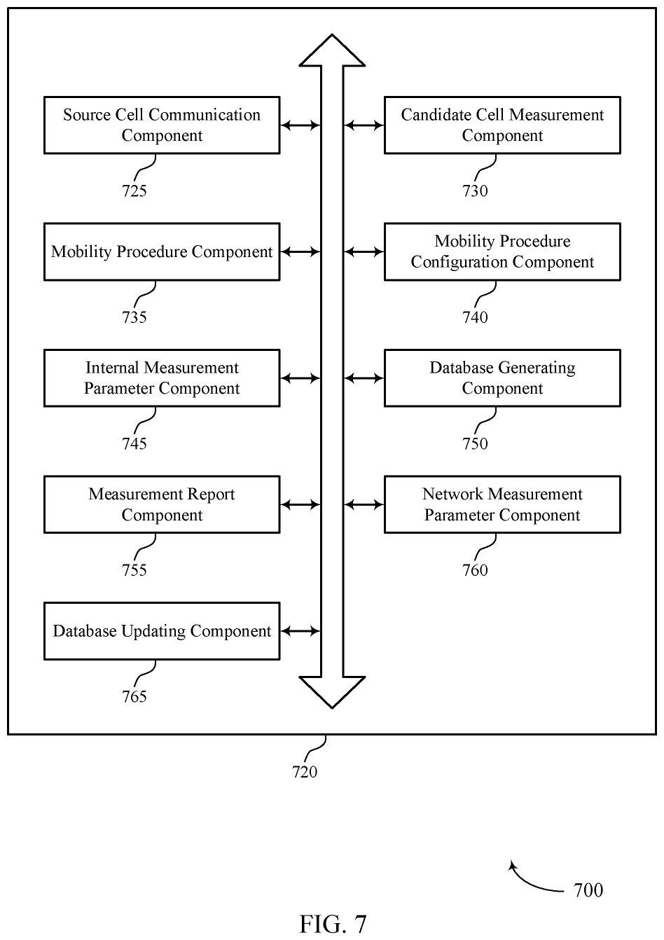

FIG. 7 shows a block diagram 700 of a communications manager 720 that supports candidate cell detection for standalone mode in accordance with aspects of the present disclosure. The communications manager 720 may be an example of aspects of a communications manager 520, a communications manager 620, or both, as described herein. The communications manager 720, or various components thereof, may be an example of means for performing various aspects of candidate cell detection for standalone mode as described herein. For example, the communications manager 720 may include a source cell communication component 725, a candidate cell measurement component 730, a mobility procedure component 735, a mobility procedure configuration component 740, an internal measurement parameter component 745, a database generating component 750, a measurement report component 755, a network measurement parameter component 760, a database updating component 765, or any combination thereof. Each of these components may communicate, directly or indirectly, with one another (e.g., via one or more buses).

The communications manager 720 may support wireless communications at a UE in accordance with examples as disclosed herein. The source cell communication component 725 may be configured as or otherwise support a means for communicating with a base station according to a first radio access technology in a first frequency range. The candidate cell measurement component 730 may be configured as or otherwise support a means for performing measurements on a set of candidate cells of a second radio access technology or a second frequency range based on a determination for the UE to operate according to the second radio access technology or the second frequency range. The mobility procedure component 735 may be configured as or otherwise support a means for performing a mobility procedure to establish a connection with a first cell of the set of candidate cells based on a determination that a first value of a first measurement parameter for the first cell satisfies a first threshold, and further based on a comparison of a second value of a second measurement parameter for the first cell to a second threshold, the first measurement parameter being different from the second measurement parameter.

In some examples, the mobility procedure configuration component 740 may be configured as or otherwise support a means for receiving, from the base station, a configuration identifying resources for the UE to measure, where the configuration indicates the first measurement parameter. In some examples, the internal measurement parameter component 745 may be configured as or otherwise support a means for determining, by the UE, the second measurement parameter based on the first measurement parameter.

In some examples, the mobility procedure configuration component 740 may be configured as or otherwise support a means for receiving, from the base station, an indication for the UE to perform the mobility procedure. In some examples, the internal measurement parameter component 745 may be configured as or otherwise support a means for determining, by the UE, the first measurement parameter and the second measurement parameter.

In some examples, the database generating component 750 may be configured as or otherwise support a means for generating a database of measurements made by the UE of the second radio access technology or the second frequency range before the determination for the UE to operate according to the second radio access technology or the second frequency range, where the second threshold is determined based on the database of measurements.

In some examples, the network measurement parameter component 760 may be configured as or otherwise support a means for receiving, from the base station, an indication of the first threshold. In some examples, the network measurement parameter component 760 may be configured as or otherwise support a means for modifying the first threshold based on the database of measurements of the second radio access technology or the second frequency range.

In some examples, the database generating component 750 may be configured as or otherwise support a means for generating, in the database of measurements, a history of measurements for each idle neighboring cell or connected neighboring cell corresponding to the set of candidate cells made before the determination for the UE to operate according to the second radio access technology or the second frequency range.

In some examples, the candidate cell measurement component 730 may be configured as or otherwise support a means for identifying the set of candidate cells based on the database of measurements. In some examples, the first value of the first measurement parameter and the second value of the second measurement parameter are obtained from the database of measurements.

In some examples, to support generating the database of measurements, the database generating component 750 may be configured as or otherwise support a means for generating the database of measurements based on measurements made for the set of candidate cells according to the first measurement parameter and the second measurement parameter before the determination for the UE to operate according to the second radio access technology or the second frequency range. In some examples, the database updating component 765 may be configured as or otherwise support a means for updating the database of measurements based on more recent measurements for the set of candidate cells.

In some examples, the candidate cell measurement component 730 may be configured as or otherwise support a means for comparing a third value of the first measurement parameter for a second cell of the set of candidate cells to the first threshold, where the third value satisfies the first threshold. In some examples, the candidate cell measurement component 730 may be configured as or otherwise support a means for comparing a fourth value of the second measurement parameter for the second cell to the second threshold, where the fourth value fails to satisfy the second threshold. In some examples, the candidate cell measurement component 730 may be configured as or otherwise support a means for initiating a monitoring window for measuring the set of candidate cells based on the fourth value failing to satisfy the second threshold.

In some examples, the candidate cell measurement component 730 may be configured as or otherwise support a means for comparing a fifth value of the first measurement parameter for a third cell of the set of candidate cells to the first threshold, where the third value satisfies the first threshold. In some examples, the candidate cell measurement component 730 may be configured as or otherwise support a means for comparing a sixth value of the second measurement parameter for the third cell to the second threshold, where the sixth value fails to satisfy the second threshold. In some examples, the candidate cell measurement component 730 may be configured as or otherwise support a means for storing an indicator for the third cell based on the sixth value of the second measurement parameter being higher than the fourth value. In some examples, starting a measurement window timer after performing measurements on the second cell. In some examples, the third cell is measured after an expiration of the measurement window timer.

In some examples, the candidate cell measurement component 730 may be configured as or otherwise support a means for comparing the first value of the first measurement parameter for the first cell of the set of candidate cells to the first threshold, where the first value satisfies the first threshold. In some examples, the candidate cell measurement component 730 may be configured as or otherwise support a means for comparing the second value of the second measurement parameter for the first cell to the second threshold, where the second value satisfies the second threshold, and where the mobility procedure is performed based on the second value of the second measurement parameter satisfying the second threshold.

In some examples, a duration for the monitoring window is based on a mobility timeline requirement, a radio resource control connection status, a number of candidate cells of the set of candidate cells, or any combination thereof. In some examples, the candidate cell measurement component 730 may be configured as or otherwise support a means for comparing a third value of the first measurement parameter for a second cell of the set of candidate cells to the first threshold, where the third value fails to satisfy the first threshold. In some examples, the candidate cell measurement component 730 may be configured as or otherwise support a means for removing the second cell from the set of candidate cells.

In some examples, the candidate cell measurement component 730 may be configured as or otherwise support a means for comparing the first value of the first measurement parameter for the first cell of the set of candidate cells to the first threshold, where the first value satisfies the first threshold. In some examples, the candidate cell measurement component 730 may be configured as or otherwise support a means for comparing the second value of the second measurement parameter for the first cell to the second threshold, where the second value satisfies the second threshold, and where the mobility procedure is performed based on the second value of the second measurement parameter satisfying the second threshold.

In some examples, the measurement report component 755 may be configured as or otherwise support a means for transmitting, to the base station, a measurement report indicating the first cell based on the second value of the second measurement parameter for the first cell. In some examples, the candidate cell measurement component 730 may be configured as or otherwise support a means for comparing the second value to a set of values generated for the second measurement parameter for at least a portion of the set of candidate cells, where the second value is higher than each value of the set of values.

In some examples, the mobility procedure is a cell reselection procedure, a cell redirection procedure, or a handover. In some examples, the first measurement parameter is a reference signal received power, and the second measurement parameter is a reference signal received quality, or a signal to interference plus noise ratio, or a combination thereof.

In some examples, the first radio access technology and the second radio access technology are a same radio access technology. In some examples, the first radio access technology is a different radio access technology from the second radio access technology.

In some examples, the first radio access technology is New Radio and the second radio access technology is Long Term Evolution. In some examples, the first frequency range and the second frequency range are a same frequency range. In some examples, the first frequency range is a different frequency range from the second frequency range. In some examples, the first frequency range is Frequency Range 2 and the second frequency range is Frequency Range 1 or Frequency Range.

In some cases, the source cell communication component 725, the candidate cell measurement component 730, the mobility procedure component 735, the mobility procedure configuration component 740, the internal measurement parameter component 745, the database generating component 750, the measurement report component 755, the network measurement parameter component 760, and the database updating component 765 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of [copy-paste in the independent and dependent claim modules within the communication manager] discussed herein.

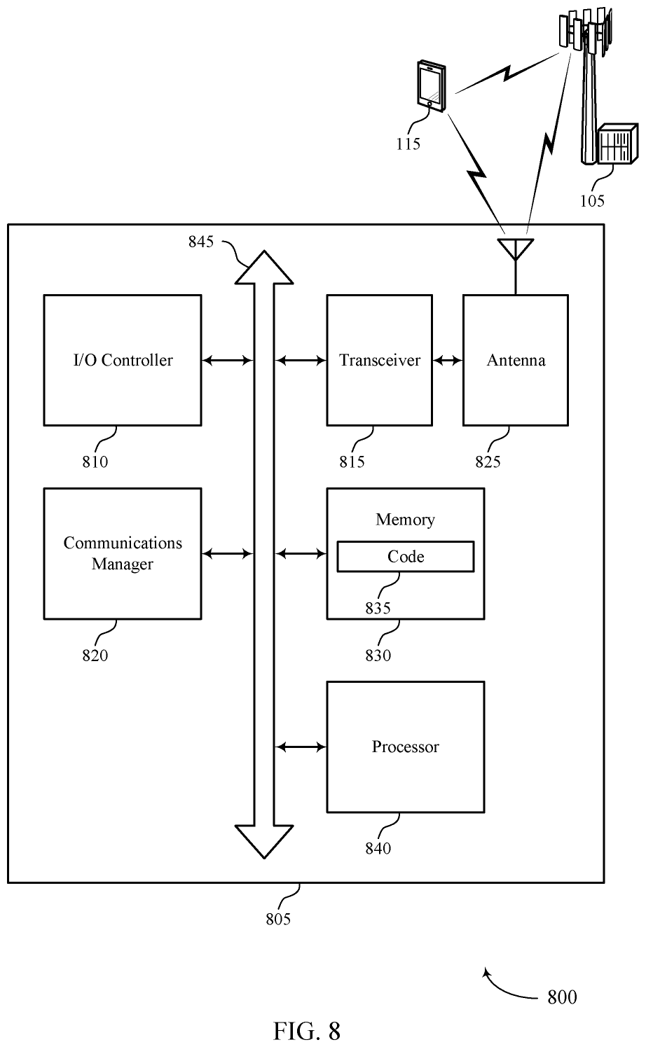

FIG. 8 shows a diagram of a system 800 including a device 805 that supports candidate cell detection for standalone mode in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting candidate cell detection for standalone mode). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for communicating with a base station according to a first radio access technology in a first frequency range. The communications manager 820 may be configured as or otherwise support a means for performing measurements on a set of candidate cells of a second radio access technology or a second frequency range based on a determination for the UE to operate according to the second radio access technology or the second frequency range. The communications manager 820 may be configured as or otherwise support a means for performing a mobility procedure to establish a connection with a first cell of the set of candidate cells based on a determination that a first value of a first measurement parameter for the first cell satisfies a first threshold, and further based on a comparison of a second value of a second measurement parameter for the first cell to a second threshold, the first measurement parameter being different from the second measurement parameter.

By including or configuring the communications manager 820 in accordance with examples as described herein, the device 805 may support techniques These techniques may reduce an interaction failure rate between RATs of an inter-RAT mobility procedure. Additionally, these techniques may enable a UE 115 to camp on a cell with higher quality and signal strength to improve voice communications and throughput performance. Additionally, the UE 115 may avoid frequent mobility procedures, which may be caused by selecting cells with low signal quality, ensuring robust voice communications setup and network maintenance.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of candidate cell detection for standalone mode as described herein, or the processor 840 and the memory 830 may be otherwise configured to perform or support such operations.

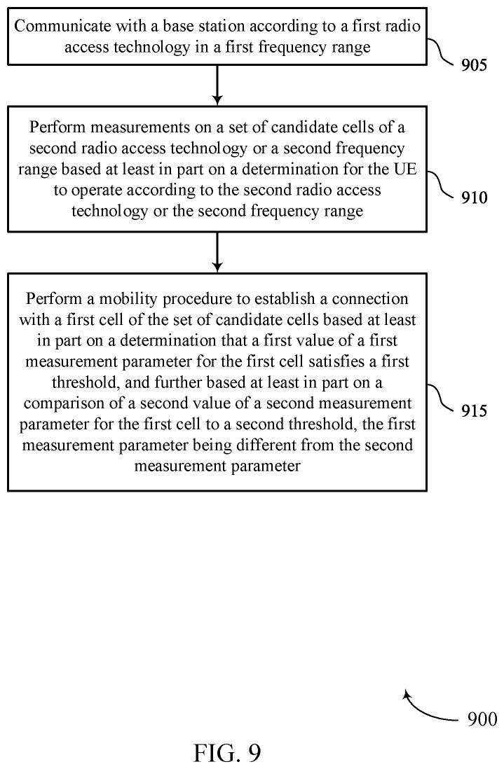

FIG. 9 shows a flowchart illustrating a method 900 that supports candidate cell detection for standalone mode in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include communicating with a base station according to a first radio access technology in a first frequency range. The operations of 905 may be performed in accordance with examples as disclosed herein. In some examples, aspects of the operations of 905 may be performed by a source cell communication component 725 as described with reference to FIG. 7.

At 910, the method may include performing measurements on a set of candidate cells of a second radio access technology or a second frequency range based on a determination for the UE to operate according to the second radio access technology or the second frequency range. The operations of 910 may be performed in accordance with examples as disclosed herein. In some examples, aspects of the operations of 910 may be performed by a candidate cell measurement component 730 as described with reference to FIG. 7.

At 915, the method may include performing a mobility procedure to establish a connection with a first cell of the set of candidate cells based on a determination that a first value of a first measurement parameter for the first cell satisfies a first threshold, and further based on a comparison of a second value of a second measurement parameter for the first cell to a second threshold, the first measurement parameter being different from the second measurement parameter. The operations of 915 may be performed in accordance with examples as disclosed herein. In some examples, aspects of the operations of 915 may be performed by a mobility procedure component 735 as described with reference to FIG. 7.

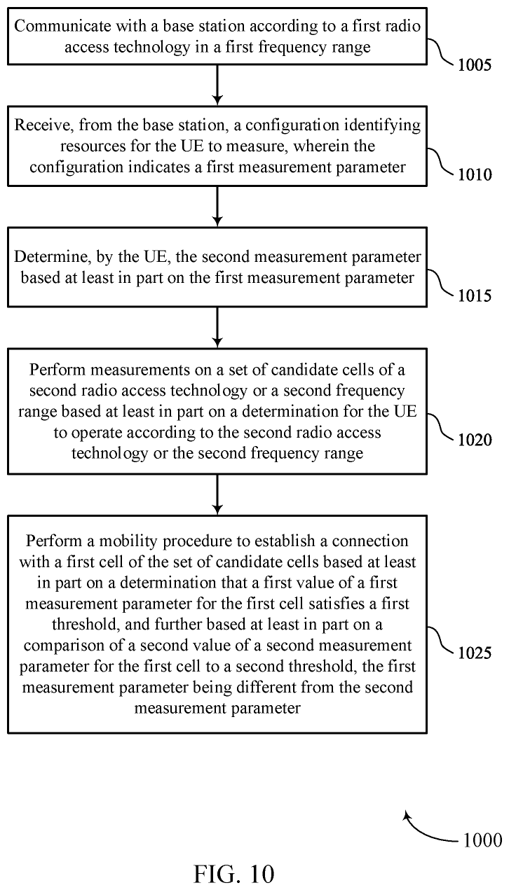

FIG. 10 shows a flowchart illustrating a method 1000 that supports candidate cell detection for standalone mode in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may include communicating with a base station according to a first radio access technology in a first frequency range. The operations of 1005 may be performed in accordance with examples as disclosed herein. In some examples, aspects of the operations of 1005 may be performed by a source cell communication component 725 as described with reference to FIG. 7.

At 1010, the method may include receiving, from the base station, a configuration identifying resources for the UE to measure, where the configuration indicates the first measurement parameter. The operations of 1010 may be performed in accordance with examples as disclosed herein. In some examples, aspects of the operations of 1010 may be performed by a mobility procedure configuration component 740 as described with reference to FIG. 7.

At 1015, the method may include determining, by the UE, the second measurement parameter based on the first measurement parameter. The operations of 1015 may be performed in accordance with examples as disclosed herein. In some examples, aspects of the operations of 1015 may be performed by an internal measurement parameter component 745 as described with reference to FIG. 7.

At 1020, the method may include performing measurements on a set of candidate cells of a second radio access technology or a second frequency range based on a determination for the UE to operate according to the second radio access technology or the second frequency range. The operations of 1020 may be performed in accordance with examples as disclosed herein. In some examples, aspects of the operations of 1020 may be performed by a candidate cell measurement component 730 as described with reference to FIG. 7.

At 1025, the method may include performing a mobility procedure to establish a connection with a first cell of the set of candidate cells based on a determination that a first value of a first measurement parameter for the first cell satisfies a first threshold, and further based on a comparison of a second value of a second measurement parameter for the first cell to a second threshold, the first measurement parameter being different from the second measurement parameter. The operations of 1025 may be performed in accordance with examples as disclosed herein. In some examples, aspects of the operations of 1025 may be performed by a mobility procedure component 735 as described with reference to FIG. 7.

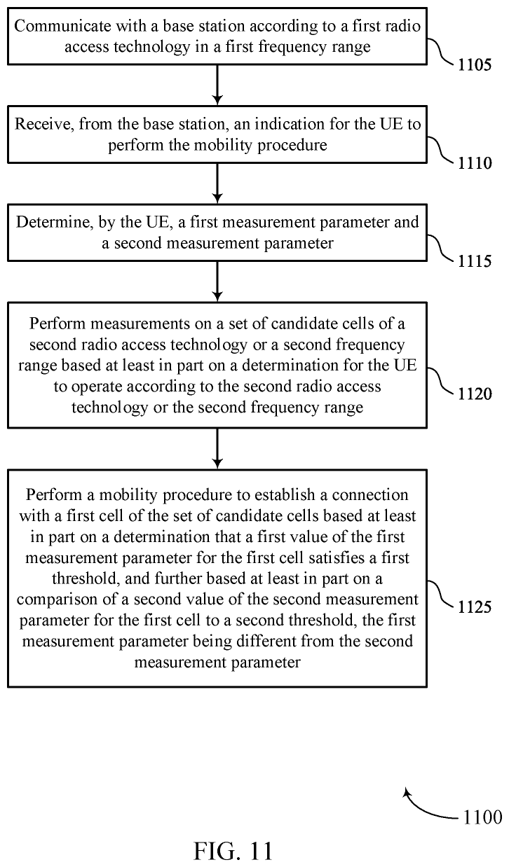

FIG. 11 shows a flowchart illustrating a method 1100 that supports candidate cell detection for standalone mode in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1105, the method may include communicating with a base station according to a first radio access technology in a first frequency range. The operations of 1105 may be performed in accordance with examples as disclosed herein. In some examples, aspects of the operations of 1105 may be performed by a source cell communication component 725 as described with reference to FIG. 7.

At 1110, the method may include receiving, from the base station, an indication for the UE to perform the mobility procedure. The operations of 1110 may be performed in accordance with examples as disclosed herein. In some examples, aspects of the operations of 1110 may be performed by a mobility procedure configuration component 740 as described with reference to FIG. 7.

At 1115, the method may include determining, by the UE, the first measurement parameter and the second measurement parameter. The operations of 1115 may be performed in accordance with examples as disclosed herein. In some examples, aspects of the operations of 1115 may be performed by an internal measurement parameter component 745 as described with reference to FIG. 7.

At 1120, the method may include performing measurements on a set of candidate cells of a second radio access technology or a second frequency range based on a determination for the UE to operate according to the second radio access technology or the second frequency range. The operations of 1120 may be performed in accordance with examples as disclosed herein. In some examples, aspects of the operations of 1120 may be performed by a candidate cell measurement component 730 as described with reference to FIG. 7.

At 1125, the method may include performing a mobility procedure to establish a connection with a first cell of the set of candidate cells based on a determination that a first value of a first measurement parameter for the first cell satisfies a first threshold, and further based on a comparison of a second value of a second measurement parameter for the first cell to a second threshold, the first measurement parameter being different from the second measurement parameter. The operations of 1125 may be performed in accordance with examples as disclosed herein. In some examples, aspects of the operations of 1125 may be performed by a mobility procedure component 735 as described with reference to FIG. 7.

The following provides an overview of aspects of the present disclosure:

Aspect 1: A method for wireless communications at a UE, comprising: communicating with a base station according to a first radio access technology in a first frequency range; performing measurements on a set of candidate cells of a second radio access technology or a second frequency range based at least in part on a determination for the UE to operate according to the second radio access technology or the second frequency range; and performing a mobility procedure to establish a connection with a first cell of the set of candidate cells based at least in part on a determination that a first value of a first measurement parameter for the first cell satisfies a first threshold, and further based at least in part on a comparison of a second value of a second measurement parameter for the first cell to a second threshold, the first measurement parameter being different from the second measurement parameter.

Aspect 2: The method of aspect 1, further comprising: receiving, from the base station, a configuration identifying resources for the UE to measure, wherein the configuration indicates the first measurement parameter; and determining, by the UE, the second measurement parameter based at least in part on the first measurement parameter.

Aspect 3: The method of any of aspects 1 through 2, further comprising: receiving, from the base station, an indication for the UE to perform the mobility procedure; and determining, by the UE, the first measurement parameter and the second measurement parameter.

Aspect 4: The method of aspect 1, further comprising: generating a database of measurements made by the UE of the second radio access technology or the second frequency range before the determination for the UE to operate according to the second radio access technology or the second frequency range, wherein the second threshold is determined based at least in part on the database of measurements.

Aspect 5: The method of aspect 4, further comprising: receiving, from the base station, an indication of the first threshold; and modifying the first threshold based at least in part on the database of measurements of the second radio access technology or the second frequency range.

Aspect 6: The method of any of aspects 4 through 5, further comprising: generating, in the database of measurements, a history of measurements for each idle neighboring cell or connected neighboring cell corresponding to the set of candidate cells made before the determination for the UE to operate according to the second radio access technology or the second frequency range.

Aspect 7: The method of any of aspects 4 through 6, further comprising: identifying the set of candidate cells based at least in part on the database of measurements.

Aspect 8: The method of any of aspects 4 through 7, wherein the first value of the first measurement parameter and the second value of the second measurement parameter are obtained from the database of measurements.

Aspect 9: The method of any of aspects 4 through 8, wherein generating the database of measurements comprises: generating the database of measurements based at least in part on measurements made for the set of candidate cells according to the first measurement parameter and the second measurement parameter before the determination for the UE to operate according to the second radio access technology or the second frequency range.

Aspect 10: The method of any of aspects 4 through 9, further comprising: updating the database of measurements based at least in part on more recent measurements for the set of candidate cells.

Aspect 11: The method of any of aspects 1 through 10, further comprising: comparing a third value of the first measurement parameter for a second cell of the set of candidate cells to the first threshold, wherein the third value satisfies the first threshold; comparing a fourth value of the second measurement parameter for the second cell to the second threshold, wherein the fourth value fails to satisfy the second threshold; and initiating a monitoring window for measuring the set of candidate cells based at least in part on the fourth value failing to satisfy the second threshold.

Aspect 12: The method of aspect 11, further comprising: comparing a fifth value of the first measurement parameter for a third cell of the set of candidate cells to the first threshold, wherein the third value satisfies the first threshold; and comparing a sixth value of the second measurement parameter for the third cell to the second threshold, wherein the sixth value fails to satisfy the second threshold; and storing an indicator for the third cell based at least in part on the sixth value of the second measurement parameter being higher than the fourth value.

Aspect 13: The method of aspect 12, wherein starting a measurement window timer after performing measurements on the second cell, the third cell is measured after an expiration of the measurement window timer.

Aspect 14: The method of any of aspects 11 through 13, further comprising: comparing the first value of the first measurement parameter for the first cell of the set of candidate cells to the first threshold, wherein the first value satisfies the first threshold; and comparing the second value of the second measurement parameter for the first cell to the second threshold, wherein the second value satisfies the second threshold, and wherein the mobility procedure is performed based at least in part on the second value of the second measurement parameter satisfying the second threshold.

Aspect 15: The method of any of aspects 11 through 14, wherein a duration for the monitoring window is based at least in part on a mobility timeline requirement, a radio resource control connection status, a number of candidate cells of the set of candidate cells, or any combination thereof.

Aspect 16: The method of any of aspects 1 through 15, further comprising: comparing a third value of the first measurement parameter for a second cell of the set of candidate cells to the first threshold, wherein the third value fails to satisfy the first threshold; and removing the second cell from the set of candidate cells.

Aspect 17: The method of aspect 16, further comprising: comparing the first value of the first measurement parameter for the first cell of the set of candidate cells to the first threshold, wherein the first value satisfies the first threshold; and comparing the second value of the second measurement parameter for the first cell to the second threshold, wherein the second value satisfies the second threshold, and wherein the mobility procedure is performed based at least in part on the second value of the second measurement parameter satisfying the second threshold.

Aspect 18: The method of any of aspects 1 through 17, further comprising: transmitting, to the base station, a measurement report indicating the first cell based at least in part on the second value of the second measurement parameter for the first cell.

Aspect 19: The method of any of aspects 1 through 18, further comprising: comparing the second value to a set of values generated for the second measurement parameter for at least a portion of the set of candidate cells, wherein the second value is higher than each value of the set of values.

Aspect 20: The method of any of aspects 1 through 19, wherein the mobility procedure is a cell reselection procedure, a cell redirection procedure, or a handover.

Aspect 21: The method of any of aspects 1 through 20, wherein the first measurement parameter is a reference signal received power, and the second measurement parameter is a reference signal received quality, or a signal to interference plus noise ratio, or a combination thereof.

Aspect 22: The method of any of aspects 1 through 21, wherein the first radio access technology and the second radio access technology are a same radio access technology.

Aspect 23: The method of any of aspects 1 through 21, wherein the first radio access technology is a different radio access technology from the second radio access technology.

Aspect 24: The method of aspect 23, wherein the first radio access technology is New Radio and the second radio access technology is Long Term Evolution.

Aspect 25: The method of any of aspects 1 through 24, wherein the first frequency range and the second frequency range are a same frequency range.

Aspect 26: The method of any of aspects 1 through 24, wherein the first frequency range is a different frequency range from the second frequency range.

Aspect 27: The method of aspect 26, wherein the first frequency range is Frequency Range 2 and the second frequency range is Frequency Range 1 or Frequency Range

[symbol]

Aspect 28: An apparatus for wireless communications at a UE, comprising a processor; memory coupled with the processor; and instructions stored in the memory and executable by the processor to cause the apparatus to perform a method of any of aspects 1 through 27.

Aspect 29: An apparatus for wireless communications at a UE, comprising at least one means for performing a method of any of aspects 1 through 27.

Aspect 30: A non-transitory computer-readable medium storing code for wireless communications at a UE, the code comprising instructions executable by a processor to perform a method of any of aspects 1 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1-27. (canceled)

28. An apparatus for wireless communications at a user equipment (UE), comprising:
at least one memory; and
at least one processor coupled to the at least one memory, the at least one processor configured to:
communicate with a base station according to a first radio access technology in a first frequency range;
perform measurements on a set of candidate cells of a second radio access technology or a second frequency range based at least in part on a determination for the UE to operate according to the second radio access technology or the second frequency range; and
perform a mobility procedure to establish a connection with a first cell of the set of candidate cells based at least in part on a determination that a first value of a first measurement parameter for the first cell satisfies a first threshold, and further based at least in part on a comparison of a second value of a second measurement parameter for the first cell to a second threshold, the first measurement parameter being different from the second measurement parameter.

29. The apparatus of claim 28, wherein the at least one processor is configured to:
receive, from the base station, a configuration identifying resources for the UE to measure, wherein the configuration indicates the first measurement parameter; and
determine, by the UE, the second measurement parameter based at least in part on the first measurement parameter.

30. The apparatus of claim 28, wherein the at least one processor is configured to:
receive, from the base station, an indication for the UE to perform the mobility procedure; and
determine, by the UE, the first measurement parameter and the second measurement parameter.

31. The apparatus of claim 28, wherein the at least one processor is configured to:
generate a database of measurements made by the UE of the second radio access technology or the second frequency range before the determination for the UE to operate according to the second radio access technology or the second frequency range, wherein the second threshold is determined based at least in part on the database of measurements.

32. The apparatus of claim 31, wherein the at least one processor is configured to:
receive, from the base station, an indication of the first threshold; and
modify the first threshold based at least in part on the database of measurements of the second radio access technology or the second frequency range.

33. The apparatus of claim 31, wherein the at least one processor is configured to:
generate, in the database of measurements, a history of measurements for each idle neighboring cell or connect neighboring cell corresponding to the set of candidate cells made before the determination for the UE to operate according to the second radio access technology or the second frequency range.

34. The apparatus of claim 31, wherein the at least one processor is configured to:
identify the set of candidate cells based at least in part on the database of measurements.

35. The apparatus of claim 31, wherein the first value of the first measurement parameter and the second value of the second measurement parameter are obtained from the database of measurements.

36. The apparatus of claim 31, wherein, to generate the database of measurements, the at least one processor is configured to:
generate the database of measurements based at least in part on measurements made for the set of candidate cells according to the first measurement parameter and the second measurement parameter before the determination for the UE to operate according to the second radio access technology or the second frequency range.

37. The apparatus of claim 31, wherein the at least one processor is configured to:
update the database of measurements based at least in part on more recent measurements for the set of candidate cells.

38. The apparatus of claim 28, wherein the at least one processor is configured to:
compare a third value of the first measurement parameter for a second cell of the set of candidate cells to the first threshold, wherein the third value satisfies the first threshold;
compare a fourth value of the second measurement parameter for the second cell to the second threshold, wherein the fourth value fails to satisfy the second threshold; and
initiate a monitoring window for measuring the set of candidate cells based at least in part on the fourth value failing to satisfy the second threshold.

39. The apparatus of claim 38, wherein the at least one processor is configured to:
compare a fifth value of the first measurement parameter for a third cell of the set of candidate cells to the first threshold, wherein the third value satisfies the first threshold;
compare a sixth value of the second measurement parameter for the third cell to the second threshold, wherein the sixth value fails to satisfy the second threshold; and
store an indicator for the third cell based at least in part on the sixth value of the second measurement parameter being higher than the fourth value.

40. The apparatus of claim 39, wherein the at least one processor is configured to:
start a measurement window timer after performing measurements on the second cell, wherein the third cell is measured after an expiration of the measurement window timer.

41. The apparatus of claim 38, wherein the at least one processor is configured to:
compare the first value of the first measurement parameter for the first cell of the set of candidate cells to the first threshold, wherein the first value satisfies the first threshold; and
compare the second value of the second measurement parameter for the first cell to the second threshold, wherein the second value satisfies the second threshold, and wherein the mobility procedure is performed based at least in part on the second value of the second measurement parameter satisfying the second threshold.

42. The apparatus of claim 38, wherein a duration for the monitoring window is based at least in part on a mobility timeline requirement, a radio resource control connection status, a number of candidate cells of the set of candidate cells, or any combination thereof.

43. The apparatus of claim 28, wherein the at least one processor is configured to:
compare a third value of the first measurement parameter for a second cell of the set of candidate cells to the first threshold, wherein the third value fails to satisfy the first threshold; and
remove the second cell from the set of candidate cells.

44. The apparatus of claim 43, wherein the at least one processor is configured to:
compare the first value of the first measurement parameter for the first cell of the set of candidate cells to the first threshold, wherein the first value satisfies the first threshold; and
compare the second value of the second measurement parameter for the first cell to the second threshold, wherein the second value satisfies the second threshold, and wherein the mobility procedure is performed based at least in part on the second value of the second measurement parameter satisfying the second threshold.

45. The apparatus of claim 28, wherein the at least one processor is configured to:
transmit, to the base station, a measurement report indicating the first cell based at least in part on the second value of the second measurement parameter for the first cell.

46. The apparatus of claim 28, wherein the at least one processor is configured to:
compare the second value to a set of values generated for the second measurement parameter for at least a portion of the set of candidate cells, wherein the second value is higher than each value of the set of values.

47. The apparatus of claim 28, wherein the mobility procedure is a cell reselection procedure, a cell redirection procedure, or a handover.

48. The apparatus of claim 28, wherein the first measurement parameter is a reference signal received power, and the second measurement parameter is a reference signal received quality, or a signal to interference plus noise ratio, or a combination thereof.

49. The apparatus of claim 28, wherein the first radio access technology and the second radio access technology are a same radio access technology.

50. The apparatus of claim 28, wherein the first radio access technology is a different radio access technology from the second radio access technology.

51. The apparatus of claim 50, wherein the first radio access technology is New Radio and the second radio access technology is Long Term Evolution.

52. The apparatus of claim 28, wherein the first frequency range and the second frequency range are a same frequency range.

53. The apparatus of claim 28, wherein the first frequency range is a different frequency range from the second frequency range.

54. The apparatus of claim 53, wherein the first frequency range is Frequency Range 2 and the second frequency range is Frequency Range 1 or Frequency Range.

55. An apparatus for wireless communications at a user equipment (UE), comprising:
means for communicating with a base station according to a first radio access technology in a first frequency range;
means for performing measurements on a set of candidate cells of a second radio access technology or a second frequency range based at least in part on a determination for the UE to operate according to the second radio access technology or the second frequency range; and
means for performing a mobility procedure to establish a connection with a first cell of the set of candidate cells based at least in part on a determination that a first value of a first measurement parameter for the first cell satisfies a first threshold, and further based at least in part on a comparison of a second value of a second measurement parameter for the first cell to a second threshold, the first measurement parameter being different from the second measurement parameter.

56. A non-transitory computer-readable medium storing code for wireless communications at a user equipment (UE), the code comprising instructions executable by a processor to:
communicate with a base station according to a first radio access technology in a first frequency range;
perform measurements on a set of candidate cells of a second radio access technology or a second frequency range based at least in part on a determination for the UE to operate according to the second radio access technology or the second frequency range; and
perform a mobility procedure to establish a connection with a first cell of the set of candidate cells based at least in part on a determination that a first value of a first measurement parameter for the first cell satisfies a first threshold, and further based at least in part on a comparison of a second value of a second measurement parameter for the first cell to a second threshold, the first measurement parameter being different from the second measurement parameter.

57. A method for wireless communications at a user equipment (UE), comprising:
communicating with a base station according to a first radio access technology in a first frequency range;
performing measurements on a set of candidate cells of a second radio access technology or a second frequency range based at least in part on a determination for the UE to operate according to the second radio access technology or the second frequency range; and
performing a mobility procedure to establish a connection with a first cell of the set of candidate cells based at least in part on a determination that a first value of a first measurement parameter for the first cell satisfies a first threshold, and further based at least in part on a comparison of a second value of a second measurement parameter for the first cell to a second threshold, the first measurement parameter being different from the second measurement parameter.

58-83. (canceled)
